(19) United States
(12) Patent Application Publication
(10) Pub. No.: US 2025/0015748 A1
(43) Pub. Date: Jan. 9, 2025

(54) PHOTOVOLTAIC ROOFING SYSTEMS

(71) Applicant: Phase3 Photovoltaics, Inc., Portland, OR (US)

(72) Inventors: Steve Sefchick, Portland, OR (US); Ethan Good, Beaverton, OR (US); Nathan Stoddard, Chalfont, PA (US)

(21) Appl. No.: 18/219,576

(22) Filed: Jul. 7, 2023

(51) Int. Cl. H02S 20/23; E04D 3/30

(52) U.S. Cl. CPC H02S 20/23; E04D 3/30; E04D 1/16; E04D 1/20

(57) ABSTRACT

Photovoltaic roofing systems including a roof pan, a photovoltaic device, and roof covering members. The roof pan is supported on a deck of a roof. The photovoltaic device is mounted to the roof pan and includes a photovoltaic panel. The roof covering members are mounted to the deck surrounding and overlapping the roof pan to define an integrated covering. The roof covering members overlapping the roof pan inhibits water flowing to the deck underneath the integrated covering. In some examples, the photovoltaic roofing system includes one or more of an inverter, an energy storage device, a wire retainer, and a roof cap.

### BACKGROUND

The present disclosure relates generally to roofing systems. In particular, photovoltaic roofing systems are described.

Roofing systems are essential to protect homes and buildings from the elements and to maintain their structural integrity. Roofing systems typically include a deck and a plurality of cover members covering the deck, such as shingles or tiles. Roofing systems also often include vents and vent covers. These standard and traditional components of roofing systems may be referred to as conventional roofing components.

In increasing numbers, photovoltaic systems are mounted on roofs of homes and buildings to generate energy from the sun. Photovoltaic systems typically include a solar panel, electronics, and mounts to secure the system to a roof. A roofing system including a photovoltaic system may be referred to as a photovoltaic roofing system.

Known photovoltaic roofing systems are not entirely satisfactory. For example, existing photovoltaic roofing systems poorly integrate the photovoltaic system with the conventional roofing components, such as the cover members. Instead, the photovoltaic system is typically mounted on top of an existing, conventional roofing system or mounted beside conventional roofing components as a separate, disparate component.

The lack of integration results in photovoltaic roofing systems with certain drawbacks. For example, water is not managed effectively in poorly integrated photovoltaic roofing systems. Water tends to pass through seams or gaps between the photovoltaic system and the conventional roofing components, which can cause the deck to rot and/or mold to form.

Another drawback of conventional photovoltaic roofing systems is that they add to the cost and complexity of repairing or replacing conventional roofing materials. Conventional roofing materials need to be repaired or replaced over time—typically more frequently than photovoltaic roofing systems. With conventional approaches, photovoltaic roofing systems are mounted directly to conventional roofing materials. When it becomes necessary to repair or replace the conventional roofing materials in conventional approaches, the photovoltaic system must be uninstalled to access the roofing materials being repaired or replaced and then installed again once the new roofing materials are installed. It would be desirable to avoid the time, cost, and hassle of uninstalling and reinstalling the photovoltaic system whenever roofing materials need to be repaired or replaced.

Thus, there exists a need for photovoltaic roofing systems that improve upon and advance the design of known photovoltaic roofing systems. Examples of new and useful photovoltaic roofing systems relevant to the needs existing in the field are discussed below.

### SUMMARY

The present disclosure is directed to photovoltaic roofing systems including a roof pan, a photovoltaic device, and roof covering members. The roof pan is supported on a deck of a roof. The photovoltaic device is mounted to the roof pan and includes a photovoltaic panel. The roof covering members are mounted to the deck surrounding and overlapping the roof pan to define an integrated covering. The roof covering members overlapping the roof pan inhibit water from flowing to the deck underneath the integrated covering. In some examples, the photovoltaic roofing system includes one or more of an inverter, an energy storage device, a wire retainer, and a roof cap.

In some examples, the roof covering members are one or more of asphalt shingles, concrete tiles, and clay tiles.

This document describes certain examples where the roof pan is comprised of interconnected standing seam roof pans. In certain examples, the system further comprises waterproof fasteners securing the interconnected standing seam roof pans to the deck.

In select embodiments, the photovoltaic device may include a clamp coupling the photovoltaic panel to the interconnected standing seam roof pans. The interconnected standing seam roof pans may be comprised of metal. The clamp may be electrically conductive and provide an electrical grounding path between the photovoltaic panel and the interconnected standing seam roof pans.

In some examples, the number and width of the interconnected standing seam roof pans is selected to cause outermost peripheral ridges of the interconnected standing seam roof pans to align with corresponding outermost edges of the photovoltaic panel. The clamp may couple one of the outermost edges of the photovoltaic panel to one of the outermost peripheral ridges of the interconnected standing seam roof pans.

As described below, in particular instances the integrated covering covers the entire deck. In some examples, the deck may be covered by the roof covering members where the deck is not covered by the roof pan. This document describes certain examples where the roof pan terminates below a ridge of the roof and the roof covering members extend between the photovoltaic panel and the ridge. In some examples, the roof pan extends from the ridge to the gutter or cave.

In certain examples, the photovoltaic rooting system further comprises an inverter electrically coupled to the photovoltaic device. The inverter may be mounted to the roof pan between the roof pan and the photovoltaic panel.

In some examples, the photovoltaic roofing system further comprises an energy storage device. The energy storage device may be electrically coupled to the photovoltaic device and mounted to the roof pan between the roof pan and the photovoltaic panel.

In select embodiments, the roof pan includes a diverter configured to divert water around the energy storage device mounted to the roof pan.

In certain examples, the photovoltaic roofing system further comprises a wire retainer mounted to the roof pan between the roof pan and the photovoltaic panel.

In some examples, the size and shape of the roof pan and the photovoltaic panel are complementarily configured for the photovoltaic panel to visually hide the roof pan underneath the photovoltaic panel when the photovoltaic roofing system is viewed from the ground.

As described below, in particular instances the roof pan includes a top edge proximate a ridge of the roof, and the photovoltaic roofing system further comprises a roof cap extending from the ridge over the top edge of the roof pan. In certain examples, the roof cap extends laterally across the roof along the ridge and extends over the roof covering materials proximate to the ridge. The roof cap may be comprised of sheet metal.

In some examples, the photovoltaic device includes a wire, and the wire extends under the roof cap into the interior of the roof through a roof vent.

The photovoltaic panel may be spaced less than 2 inches from the roof pan to limit the space between the photovoltaic panel and the roof pan while enabling airflow between the photovoltaic panel and the roof pan.

The roof pan may include indicia defining mounting regions for the photovoltaic device.

### BRIEF DESCRIPTION OF THE DRAWINGS

FIG. 1 is a perspective view of a photovoltaic roofing system with two photovoltaic devices supported on a roof in a portrait orientation.

FIG. 2 is a plan view of the photovoltaic roofing system shown in FIG. 1 with one photovoltaic panel removed to reveal components of the photovoltaic device.

FIG. 3 is a side elevation view of the photovoltaic roofing system shown in FIG. 1

FIG. 4 is a plan view of a roof pan of the photovoltaic roofing system shown in FIG. 1 depicting indicia defining guide markings where photovoltaic device components are intended to be mounted.

FIG. 5 is a close up plan view of roof covering members in the form of concrete tiles.

FIG. 6 is a close up plan view of roof covering members in the form of clay tiles.

FIG. 7 is a plan view of a photovoltaic roofing system with two photovoltaic devices supported on a roof in a landscape orientation.

FIG. 8 is a plan view of a photovoltaic roofing system with photovoltaic devices supported on rails in a portrait orientation with one photovoltaic device removed to reveal the rails.

### DETAILED DESCRIPTION

The disclosed photovoltaic roofing systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various photovoltaic roofing systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

### Photovoltaic Roofing Systems

With reference to the figures, photovoltaic roofing systems will now be described. The photovoltaic roofing systems discussed herein function to integrate photovoltaic systems with conventional roofing components to form an integrated photovoltaic roofing system.

The reader will appreciate from the figures and description below that the presently disclosed photovoltaic roofing systems address many of the shortcomings of conventional photovoltaic roofing systems. For example, the novel photovoltaic roofing systems described below effectively integrate photovoltaic systems with conventional roofing components. Rather than merely mounting a photovoltaic system on top of an existing, conventional roofing system or separately and disparately mounting the photovoltaic system beside conventional roofing components, the novel systems below integrate the photovoltaic system components with the conventional roofing components to yield a structurally and visually seamless system.

The novel photovoltaic roofing systems described herein manage water more effectively than conventional, poorly integrated photovoltaic roofing systems. The novel systems below reduce or eliminate gaps between the photovoltaic system and the conventional roofing components that water can pass through. By reducing or eliminating the gaps, the novel systems herein avoid the deck rotting and/or mold forming from water passing through the gaps to reach the deck.

Another improvement over poorly integrated photovoltaic roofing systems is that the novel photovoltaic systems described in this document are less visually apparent and more aesthetically appealing. In the novel systems below, the photovoltaic system is more visually seamless with the conventional roofing components than in conventional systems. Further, the novel photovoltaic roofing systems described below have improved aesthetic appeal by covering the pans with the photovoltaic panels sufficient for the pans to not be visible from the ground.

The novel photovoltaic roofing systems described herein enable repairing or replacing conventional roofing materials with less expense and complexity than with existing photovoltaic roofing systems. Unlike conventional approaches, the novel photovoltaic roofing systems discussed below are not mounted directly to conventional roofing materials. As a result, the novel photovoltaic systems need not be uninstalled to access the roofing materials being repaired or replaced.

### Contextual Details

Ancillary features relevant to the photovoltaic roofing systems described herein will first be described to provide context and to aid the discussion of the photovoltaic roofing systems.

### Roof

The photovoltaic roofing systems described below are incorporated with and improve roofs of homes and buildings. In some examples, the photovoltaic roofing systems are retrofit onto an existing roof and in other examples the photovoltaic roofing systems are incorporated into the roof design from the outset.

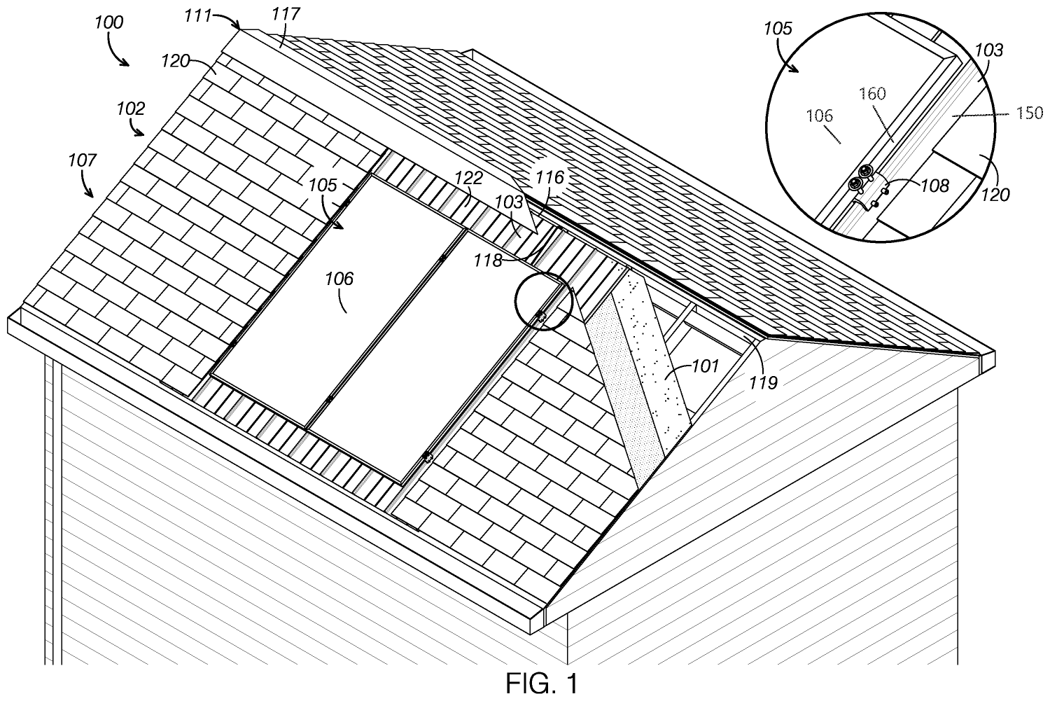

FIGS. 1-3 and others depict a suitable roof example, roof 102. Roof 102 includes a deck 101, a roof vent 119, and is covered by roof covering members 120. Suitable roofs may include a variety of additional or alternative structural members and features.

The roof may be any currently known or later developed type of roof. Various roof types exist and could be used in place of the roof shown in the figures. In addition to the types of roofs existing currently, it is contemplated that the photovoltaic roofing systems described herein could be used with new types of roofs developed in the future.

The size and shape of the roof may be varied as needed for a given application. In some examples, the roof is larger relative to the other components than depicted in the figures. In other examples, the roof is smaller relative to the other components than depicted in the figures. Further, the roof and the other components may all be larger or smaller than described herein while maintaining their relative proportions.

### Deck

The photovoltaic roofing systems described in this document are supported on decks of roofs. FIG. 1 depicts deck 101 as one example of a suitable deck.

The deck may be any currently known or later developed type of deck. Various deck types exist and could be used in place of the deck shown in the figures. In addition to the types of decks existing currently, it is contemplated that the photovoltaic roofing systems described herein could be used with new types of decks developed in the future.

The size and shape of the deck may be varied as needed for a given application. In some examples, the deck is larger relative to the other components than depicted in the figures. In other examples, the deck is smaller relative to the other components than depicted in the figures. Further, the deck and the other components may all be larger or smaller than described herein while maintaining their relative proportions.

In the present example, the deck is composed of wood. However, the deck may be composed of any currently known or later developed material suitable for decking applications. Suitable materials include metals, polymers, wood, and composite materials.

### Roof Vent

The photovoltaic roofing systems described herein may extend wires or other components through a roof vent. One example of a roof vent, roof vent 119, is depicted in FIGS. 1-3. Roof vent 119 extends laterally along the ridge of roof 102. In other examples, the roof vent is disposed between the ridge and the gutter rather than extending along the ridge.

The roof vent may be any currently known or later developed type of roof vent. Various roof vent types exist and could be used in place of the roof vent shown in the figures. In addition to the types of roof vents existing currently, it is contemplated that the photovoltaic roofing systems described herein could be used with new types of roof vents developed in the future.

The size and shape of the roof vent may be varied as needed for a given application. In some examples, the roof vent is larger relative to the other components than depicted in the figures. In other examples, the roof vent is smaller relative to the other components than depicted in the figures. Further, the roof vent and the other components may all be larger or smaller than described herein while maintaining their relative proportions.

### Photovoltaic Roofing System Embodiment One

With reference to FIGS. 1-6, a photovoltaic roofing system 100 will now be described as a first example of a photovoltaic roofing system. The reader can see in FIGS. 1-3 that photovoltaic roofing system 100 is supported on a deck 101 of a roof 102.

As shown in FIGS. 1-3, photovoltaic roofing system 100 includes roof pans 103, photovoltaic devices 105, roof covering members 120, waterproof fasteners 121, an inverter 112, an energy storage device 113, wire retainers 115, and a roof cap 117. In other examples, the photovoltaic roofing system includes fewer components than depicted in the figures. In certain examples, the photovoltaic roofing system includes additional or alternative components than depicted in the figures.

The size and shape of the photovoltaic roofing system may be varied as needed for a given application. In some examples, the photovoltaic roofing system is larger relative to the other components than depicted in the figures. In other examples, the photovoltaic roofing system is smaller relative to the other components than depicted in the figures. Further, the photovoltaic roofing system and the other components may all be larger or smaller than described herein while maintaining their relative proportions.

### Roof Pan

Roof pan 103 functions to cover and to provide a moisture barrier for a portion of deck 101. Roof pan 103 cooperates with roof covering members 120 to form an integrated covering 107. Integrated covering 107 is described in detail in a separate section below.

In the present example, roof pan 103 is comprised of interconnected standing seam roof pans 122 and includes a diverter 114 and indicia 130. The components of roof pan 103 are described in separate sections below. In some examples, the roof pan is configured differently than roof pan 103, such as including more, fewer, or alternative components.

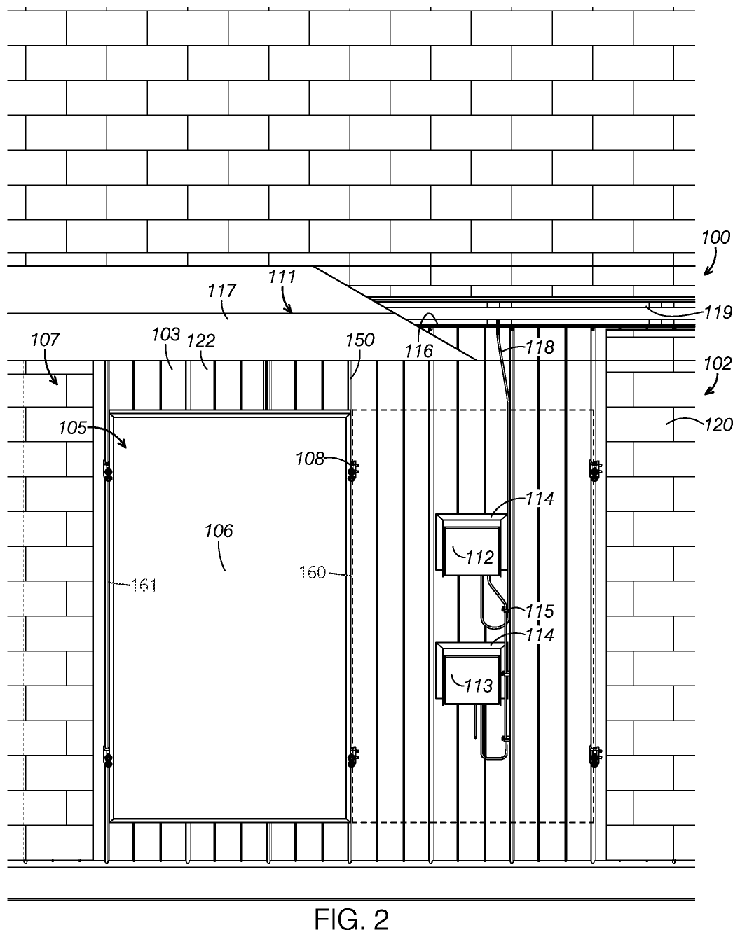

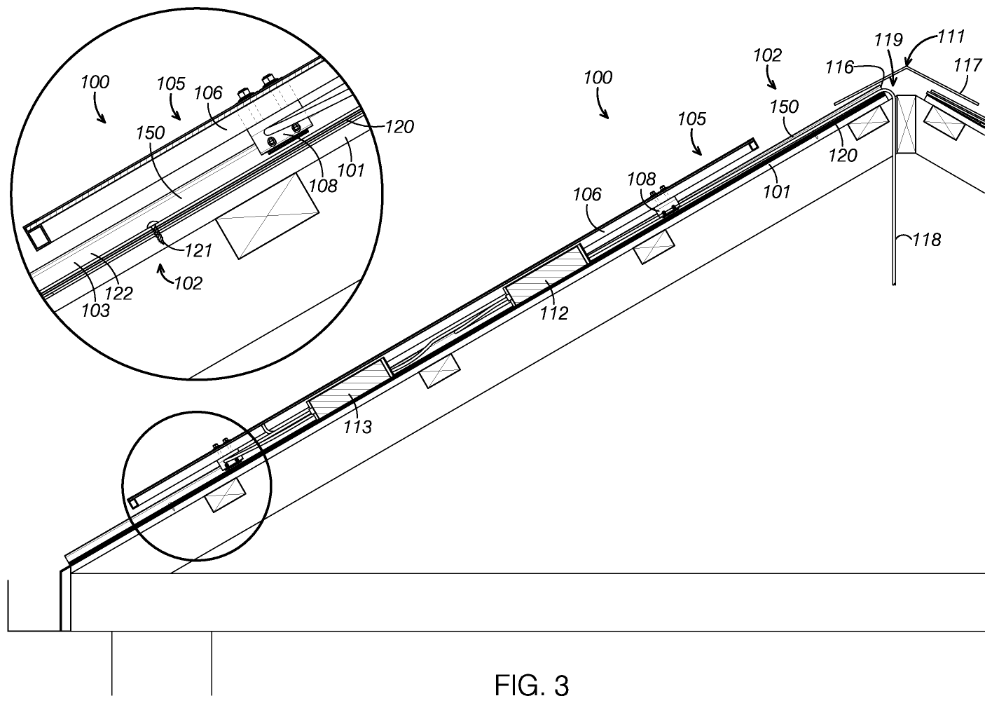

As depicted in FIGS. 1 and 2, roof pan 103 is supported on deck 101. As shown in FIG. 3, waterproof fasteners 121 secure roof pan 103 to deck 101. In other examples, the roof pan is secured to the deck via other means, such as securing the roof pan to truss members underneath the deck.

The waterproof fasteners or other fasteners may be positioned under an overlap section of a neighboring roof pan. Positioning the fastener under the overlap section reduces the fasteners' exposure to water. Thus, in this configuration, the overlap section serves as the primary means to protect against water degradation and the fastener being waterproof serves as a secondary means of protecting against water degradation.

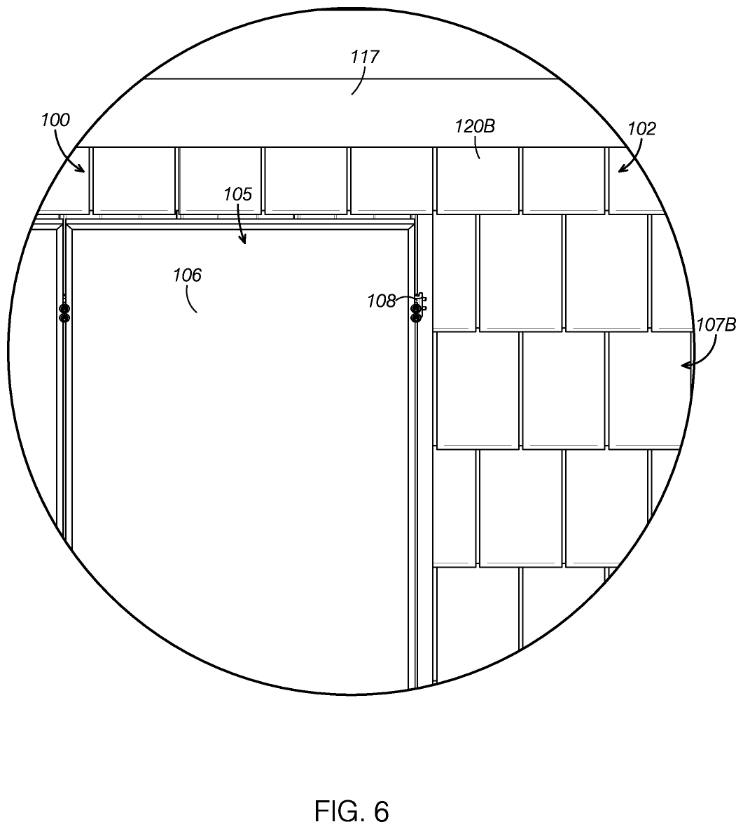

As depicted in FIGS. 1-3, roof pan 103 includes a top edge 116. Top edge 116 is proximate a ridge 111 of roof 102. As shown in FIGS. 1-3, and 5, roof pan 103 extends proximate to ridge 111 and roof vent 119. In some examples, such as shown in FIG. 6, the roof pan may terminate at a position spaced below the ridge of the roof and may be overlapped by roof covering members 120B disposed between the ridge and the top edge of the roof pan.

The roof pan may be any currently known or later developed type of roof pan. Various roof pan types exist and could be used in place of the roof pan shown in the figures. In addition to the types of roof pans existing currently, it is contemplated that the photovoltaic roofing systems described herein could incorporate new types of roof pans developed in the future.

The number of roof pans in the photovoltaic roofing system may be selected to meet the needs of a given application. The reader should appreciate that the number of roof pans may be different in other examples than is shown in the figures. For instance, some photovoltaic roofing system examples include additional or fewer roof pans than described in the present example.

The size and shape of the roof pan may be varied as needed for a given application. In some examples, the roof pan is larger relative to the other components than depicted in the figures. In other examples, the roof pan is smaller relative to the other components than depicted in the figures. Further, the roof pan and the other components may all be larger or smaller than described herein while maintaining their relative proportions.

In the present example, the roof pan is composed of metal. However, the roof pan may be composed of any currently known or later developed material suitable for roof pan applications. Suitable materials include metals, polymers, ceramics, wood, and composite materials.

### Interconnected Standing Seam Roof Pans

Interconnected standing seam roof pans 122 function to form a water barrier above deck 101. Interconnected standing seam roof pans 122 also serve as a mounting member for other components of photovoltaic roofing system 100.

Interconnected standing seam roof pans 122 include two peripheral ridges 150 and a trough 151. Peripheral ridges 150 laterally bound trough 151 and are taller than trough 151. Peripheral ridges 150 cooperate with clamps 108 to secure photovoltaic devices 105 to roof pan 103.

In the present example, there are three interconnected standing seam roof pans 122 underlying each photovoltaic panel 106. Expressed another way, each interconnected standing seam roof pan 122 has a width of ⅓^{rd} the width of photovoltaic panel 106. The 1 to 3 ratio helps align a periphery ridge 150 of each of the two outer interconnected standing seam roof pans 122 with lateral edges 160 and 161 of photovoltaic panel 106.

Other ratios of interconnected standing seam roof pans to photovoltaic panels may be used. For examples, 1:1, 2:1, 4:1, and 5 or more:1 pans to panel are acceptable. In general, whole number ratios are preferred as those width ratios provide for the outer ridges of the outermost pans to align with the outermost edges of the photovoltaic panels.

In the present example, interconnected standing seam roof pans 122 are comprised of metal, but may be comprised of any suitable material in other examples. Other types of roof pans beyond interconnected standing seam roof pans are contemplated. The size and shape of the standing seam room pans may be varied in other examples than depicted in the figures.

### Diverter

Diverter 114 is configured to divert water around components mounted to roof pan 103. In the present example, as shown in FIG. 2, diverters 114 are configured to divert water around energy storage device 113 mounted to roof pan 103 and around inverter 112 mounted to roof pan 103.

The diverter may be any currently known or later developed type of diverter. Various diverter types exist and could be used in place of the diverter shown in the figures. In addition to the types of diverters existing currently, it is contemplated that the photovoltaic roofing systems described herein could incorporate new types of diverters developed in the future.

The number of diverters in the photovoltaic roofing system may be selected to meet the needs of a given application. The reader should appreciate that the number of diverters may be different in other examples than is shown in the figures. For instance, some photovoltaic roofing system examples include additional or fewer diverters than described in the present example.

The size and shape of the diverter may be varied as needed for a given application. In some examples, the diverter is larger relative to the other components than depicted in the figures. In other examples, the diverter is smaller relative to the other components than depicted in the figures. Further, the diverter and the other components may all be larger or smaller than described herein while maintaining their relative proportions.

### Indicia

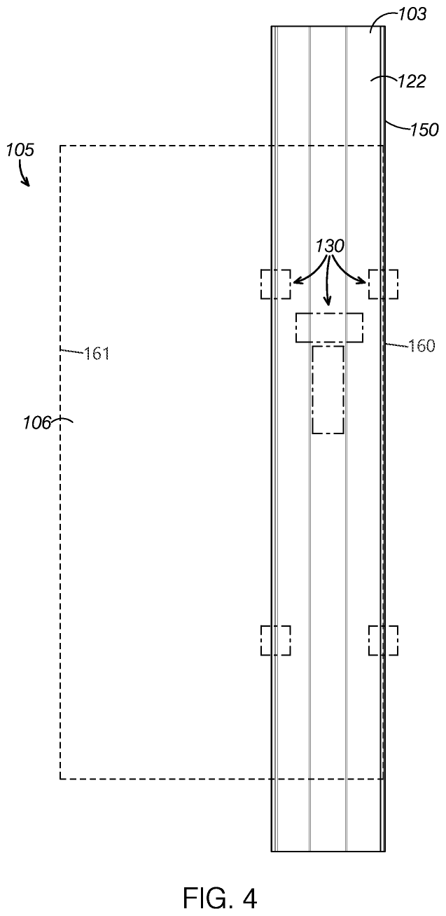

With reference to FIG. 4, roof pan 103 includes indicia 130 to facilitate installation of photovoltaic roofing system 100. In the example shown in FIG. 4, indicia 130 defines mounting regions for photovoltaic device 105. In other examples, the indicia may define mounting regions for other components of photovoltaic roofing system 100 beyond the photovoltaic device.

In the present example, indicia 130 is formed with chalk and configured to wash away over time when exposed to rain. In other examples, the indicia is indelible. Any suitable ink or marking material may be used to form the indicia.

### Waterproof Fasteners

The role of waterproof fasteners 121 is to mount roof pan 103 to roof 102. In particular, as depicted in FIG. 3, waterproof fasteners 121 secure interconnected standing seam roof pans 122 to deck 101.

The waterproof fasteners may be any currently known or later developed type of waterproof fasteners. Various waterproof fasteners types exist and could be used in place of the waterproof fasteners shown in the figures. In addition to the types of waterproof fasteners existing currently, it is contemplated that the photovoltaic roofing systems described herein could incorporate new types of waterproof fasteners developed in the future.

The number of waterproof fasteners in the photovoltaic roofing system may be selected to meet the needs of a given application. The reader should appreciate that the number of waterproof fasteners may be different in other examples than is shown in the figures. For instance, some photovoltaic roofing system examples include additional or fewer waterproof fasteners than described in the present example.

### Photovoltaic Device

The role of photovoltaic device 105 is to generate electricity from solar radiation incident on it. As shown in FIGS. 1-3, photovoltaic device 105 includes a photovoltaic panel 106, a clamp 108, and at least one wire, including wire 118. The components of photovoltaic device 105 are described in more detail in the sections below.

The photovoltaic device may be any currently known or later developed type of photovoltaic device. Various photovoltaic device types exist and could be used in place of the photovoltaic device shown in the figures. In addition to the types of photovoltaic devices existing currently, it is contemplated that the photovoltaic roofing systems described herein could incorporate new types of photovoltaic devices developed in the future.

The number of photovoltaic devices in the photovoltaic roofing system may be selected to meet the needs of a given application. The reader should appreciate that the number of photovoltaic devices may be different in other examples than is shown in the figures. For instance, some photovoltaic roofing system examples include additional or fewer photovoltaic devices than described in the present example.

The size and shape of the photovoltaic device may be varied as needed for a given application. In some examples, the photovoltaic device is larger relative to the other components than depicted in the figures. In other examples, the photovoltaic device is smaller relative to the other components than depicted in the figures. Further, the photovoltaic device and the other components may all be larger or smaller than described herein while maintaining their relative proportions.

### Photovoltaic Panel

Photovoltaic panel 106 functions to convert solar radiation into electricity. Photovoltaic panel 106 also functions to visually hide roof pan 103 to enhance the aesthetic appeal of photovoltaic roofing system 100.

As can be seen in FIGS. 1, 2, 4, and 5, photovoltaic panel 106 includes a first lateral edge 160 and a second lateral edge 161. Lateral edges 160 and 161 are collectively referred to as outermost edges of photovoltaic panel 106.

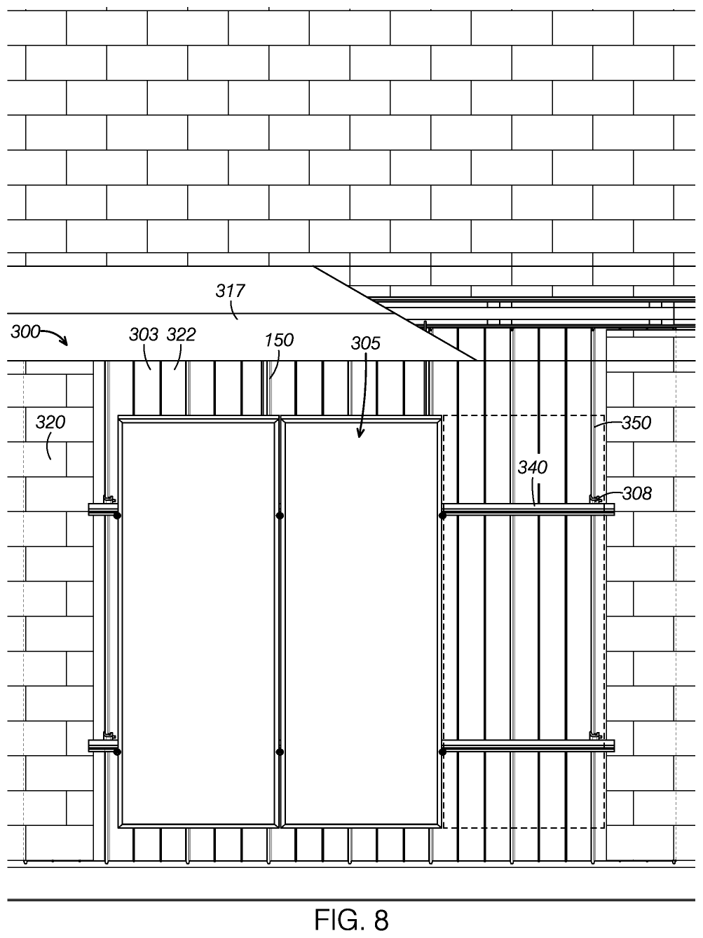

As shown in FIGS. 1-3, photovoltaic panel 106 mounts to roof pan 103. In other examples, such as shown in FIG. 8, the photovoltaic panels mount to rails. In the example shown in FIG. 8, rails 340 secure to roof pan 303 and extend across roof pan 303. Regardless of mounting method, in the examples shown in FIGS. 1-8 the photovoltaic panels are mounted above the roof pans.

As shown in FIGS. 1-3, photovoltaic panel 106 mounts to peripheral ridges 150 of roof pan 103 via clamps 108. In particular, clamps 108 couple together outermost edges 160 and 161 of photovoltaic panel with peripheral ridges 150 of interconnected standing seam roof pans 122. Clamps 108 are described in more detail in the separate section below. In other examples, the photovoltaic panel mounts to the roof pan via means other than clamps.

As shown in FIGS. 1, 2, 4, and 5, the size and shape of roof pan 103 and photovoltaic panel 106 are complementarily configured. In one aspect, roof pan 103 and photovoltaic panel 106 are complementarily configured based on the number and width of the interconnected standing seam roof pans 122 relative to the size of the photovoltaic panel 106. As shown in FIGS. 1, 2, 4, and 5, the number and width of the interconnected standing seam roof pans 122 is selected to cause outermost peripheral ridges 150 of interconnected standing seam roof pans 122 to align with corresponding outermost edges 160 and 161 of photovoltaic panel 106.

In another aspect, as shown in FIG. 1, roof pan 103 and photovoltaic panel 106 are complementarily configured to enable photovoltaic panel 106 to visually hide roof pan 103. In particular, roof pan 103 is visually hidden underneath photovoltaic panel 106 when photovoltaic roofing system 100 is viewed from the ground.

Importantly, the reader should understand that the photovoltaic panels may extend closer to the ridge of the roof and to the bottom edge of the roof than depicted in the figures to more extensively cover and visually hide the roof pan than depicted in the figures. The figures intentionally depict panels that cover the roof pans to a lesser degree to reveal the interrelationship and mounting characteristics of the photovoltaic roofing system components. The figures exaggerate gaps between the components to allow underlying components to be seen more clearly, but this disclosure contemplates examples where the gaps are minimized to intentionally obscure or visually hide underlying components for aesthetic and rain blocking purposes.

The reader can see in FIG. 3 that photovoltaic panel 106 is spaced close to trough 151 of roof pan 103, but not touching trough 151. In the particular example shown in FIG. 3, photovoltaic panel 106 is spaced less than 2 inches from trough 151. Spacing greater than 2 inches is acceptable in certain instances, but sacrifices the benefits of a close tolerance less than 2 inches. A close spacing tolerance of less than 2 inches is critical for enhanced rain protection and enhanced aesthetic appeal while still allowing for critical airflow to provide convective cooling and drying.

The close spacing between photovoltaic panel 106 and roof pan 103 more effectively shields from rain the components of photovoltaic roofing system 100 disposed between photovoltaic panel 106 and roof pan 103. For example, inverter 112 and energy storage device 113 disposed between photovoltaic panel 106 and roof pan 103 are more effectively shielded from rain when photovoltaic panel 106 is spaced less than 2 inches from trough 151. Further, the close spacing improves the aesthetic appeal of photovoltaic roofing system 100 by making photovoltaic panel 106 appear more integrated with roof covering members 120.

The close spacing between photovoltaic panel 106 and roof pan 103 is selected to enable airflow between photovoltaic panel 106 and roof pan 103. Airflow between photovoltaic panel 106 and roof pan 103 is critical to provide convective cooling and drying of components between photovoltaic panel 106 and roof pan 103.

The photovoltaic panel may be any currently known or later developed type of photovoltaic panel. Various photovoltaic panel types exist and could be used in place of the photovoltaic panel shown in the figures. In addition to the types of photovoltaic panels existing currently, it is contemplated that the photovoltaic roofing systems described herein could incorporate new types of photovoltaic panels developed in the future.

The number of photovoltaic panels in the photovoltaic roofing system may be selected to meet the needs of a given application. The reader should appreciate that the number of photovoltaic panels may be different in other examples than is shown in the figures. For instance, some photovoltaic roofing system examples include additional or fewer photovoltaic panels than described in the present example.

The size and shape of the photovoltaic panel may be varied as needed for a given application. In some examples, the photovoltaic panel is larger relative to the other components than depicted in the figures. In other examples, the photovoltaic panel is smaller relative to the other components than depicted in the figures. Further, the photovoltaic panel and the other components may all be larger or smaller than described herein while maintaining their relative proportions.

### Clamps

The reader can see in FIGS. 1-3 that clamps 108 couple photovoltaic panel 106 to peripheral ridges 150 of roof pan 103. Clamps 108 also provide an electrical grounding path for photovoltaic roofing system 100.

In the example shown in FIGS. 1-3, clamp 108 is electrically conductive. Clamp 108 being electrically conductive allows it to provide an electrical grounding path between photovoltaic panel 106 and interconnected standing seam roof pans 122.

The clamp may be any currently known or later developed type of clamp. Various clamp types exist and could be used in place of the clamp shown in the figures. In addition to the types of clamps existing currently, it is contemplated that the photovoltaic roofing systems described herein could incorporate new types of clamps developed in the future.

In the present example, each photovoltaic panel 106 is secured with four clamps 108. However, the number of clamps in the photovoltaic roofing system may be selected to meet the needs of a given application. The reader should appreciate that the number of clamps may be different in other examples than is shown in the figures. For instance, some photovoltaic roofing system examples include additional or fewer clamps than described in the present example.

The size and shape of the clamp may be varied as needed for a given application. In some examples, the clamp is larger relative to the other components than depicted in the figures. In other examples, the clamp is smaller relative to the other components than depicted in the figures. Further, the clamp and the other components may all be larger or smaller than described herein while maintaining their relative proportions.

In the present example, the clamp is composed of metal. However, the clamp may be composed of any currently known or later developed material suitable for roof clamping applications. Suitable materials include metals, polymers, ceramics, wood, and composite materials.

### Wire

Wires, such as wire 118, function to transmit electricity generated by photovoltaic panel 106 to a power system. The power system may be a power storage device, a power circuit system for a home or building, or a power transmission system to a public utility.

In the example shown in FIGS. 1-6, wire 118 coupes to energy storage device 113. In other examples, the wire couples to an inverter or a photovoltaic panel of the photovoltaic system.

In the example shown in FIGS. 1-6, the power system (not pictured) is disposed under roof 102 and wire 118 extends from photovoltaic device 105 into roof 102 to couple with the power system. As shown in FIGS. 2 and 3, wire 118 extends under roof cap 117 into the interior of roof 102 through roof vent 119.

The wire may be any currently known or later developed type of wire. Various wire types exist and could be used in place of the wire shown in the figures. In addition to the types of wires existing currently, it is contemplated that the photovoltaic roofing systems described herein could incorporate new types of wires developed in the future.

The number of wires in the photovoltaic roofing system may be selected to meet the needs of a given application. The reader should appreciate that the number of wires may be different in other examples than is shown in the figures. For instance, some photovoltaic roofing system examples include additional or fewer wires than described in the present example. The reader should understand that a wire as used herein may include multiple, separated, parallel conductors within a single cable.

### Roof Covering Members

Roof covering members 120 function to restrict water from reaching deck 101 and to direct water off of roof 102. The reader can see in FIGS. 1 and 2 that deck 101 is covered by roof covering members 120 in locations where deck 101 is not covered by roof pan 103.

As shown in FIGS. 1, 2, 5, and 6, roof covering members 120, 120A, and 120B are mounted to deck 101 adjacent to roof pan 103. The figures demonstrate that roof covering members may be mounted to deck 101 on each side of roof pan 103. As depicted in FIG. 6, roof covering members 120B extend between roof pan 103 and ridge 111. In some examples, the roof covering members mount to the deck below the roof pan as well.

With reference to FIG. 6, roof covering members 120B surround and overlap roof pan 103. Roof covering members 120B surrounding and overlapping roof pan 103 defines an integrated covering 107B. Further, roof covering members 120B overlapping roof pan 103 inhibits water flowing between roof pan 103 and roof covering members 120B to deck 101 underneath integrated covering 107B.

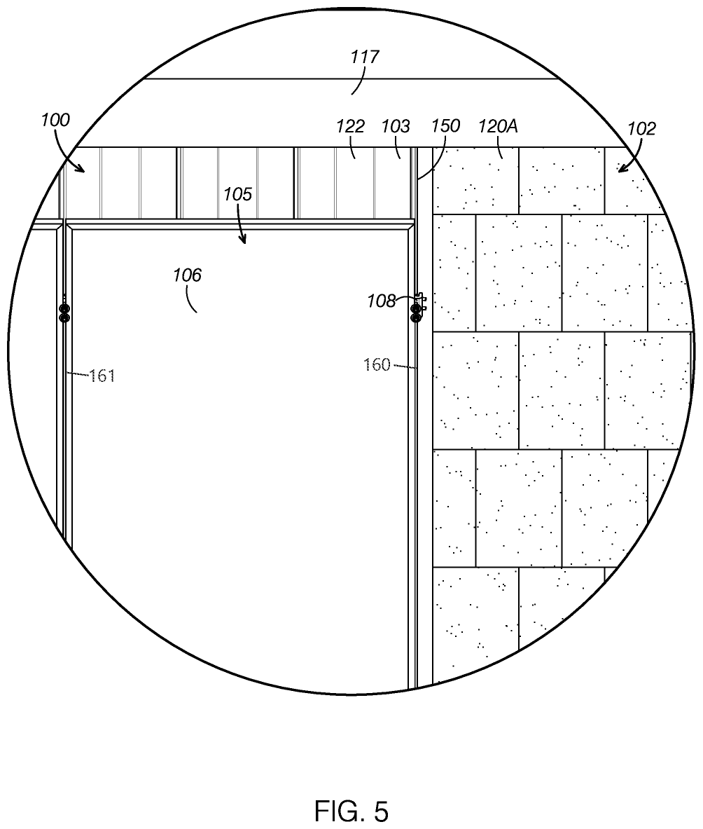

The reader can see in FIGS. 1, 2, 5, and 6 that the roof covering members may be comprised of asphalt shingles, concrete files, or clay files. In the example shown in FIGS. 1 and 2, roof covering members 120 are asphalt shingles. In the example shown in FIG. 5, roof covering members 120A are concrete files. In the example shown in FIG. 6, roof covering members 120B are clay tiles. The roof covering members may be composed of any currently known or later developed material suitable for roof covering applications.

The size and shape of the roof covering members may be varied as needed for a given application. In some examples, the roof covering members are larger relative to the other components than depicted in the figures. In other examples, the roof covering members are smaller relative to the other components than depicted in the figures. Further, the roof covering members and the other components may all be larger or smaller than described herein while maintaining their relative proportions.

### Integrated Covering

The role of integrated covering 107 is to protect deck 101 from exposure to water and other elements. Integrated covering 107 inhibits water from flowing between roof pan 103 and roof covering members 120 to deck 101 underneath integrated covering 107. Integrated covering 107 also enhances the aesthetic appeal of roof 102 and photovoltaic roofing system 100.

In the example shown in FIG. 1, integrated covering 107 covers the entirety of deck 101. In other examples, the integrated covering covers a portion of the deck less than the entirety of the deck.

### Inverter

Inverter 112 functions to convert direct current generated by photovoltaic device 105 to alternating current required by external power systems or other electrical components of photovoltaic roofing system 100, such as energy storage device 113. As depicted in FIGS. 2 and 3, inverter 112 is electrically coupled to photovoltaic device 105 and to energy storage device 113.

As further shown in FIGS. 2 and 3, inverter 112 is mounted to roof pan 103 between roof pan 103 and photovoltaic panel 106. In other examples, the inverter is mounted to the photovoltaic panel itself, attached to the frame of the photovoltaic panel, or floated above the roof pan. In the example shown in the figures, inverter 112 is mounted to roof pan 103 downstream of diverter 114 to limit its contact with water. Inverter 112 is shielded from water by diverter 114 diverting water around inverter 112.

The number of inverters in the photovoltaic roofing system may be selected to meet the needs of a given application. The reader should appreciate that the number of inverters may be different in other examples than is shown in the figures. For instance, some photovoltaic roofing system examples include additional or fewer inverters than described in the present example.

The inverter may be any currently known or later developed type of inverter. Various inverter types exist and could be used in place of the inverter shown in the figures. In addition to the types of inverters existing currently, it is contemplated that the photovoltaic roofing systems described herein could incorporate new types of inverters developed in the future.

### Energy Storage Device

Energy storage device 113 functions to store electricity generated by photovoltaic device 105. With reference to FIGS. 2 and 3, energy storage device 113 electrically coupled to photovoltaic device 105 via inverter 112.

As further shown in FIGS. 2 and 3, energy storage device 113 is mounted to roof pan 103 between roof pan 103 and photovoltaic panel 106. Energy storage device 113 is mounted to roof pan 103 downstream of diverter 114 to limit contact with water. Energy storage device 113 is shielded from water by diverter 114 diverting water around energy storage device 113.

In the present example, energy storage device 113 is a battery. The energy storage device may be any currently known or later developed type of energy storage device. Various energy storage device types exist and could be used in place of the energy storage device shown in the figures. In addition to the types of energy storage devices existing currently, it is contemplated that the photovoltaic roofing systems described herein could incorporate new types of energy storage devices developed in the future.

The number of energy storage devices in the photovoltaic roofing system may be selected to meet the needs of a given application. The reader should appreciate that the number of energy storage devices may be different in other examples than is shown in the figures. For instance, some photovoltaic roofing system examples include additional or fewer energy storage devices than described in the present example.

### Wire Retainer

Wire retainers 115 function to secure and direct wire 118. As depicted in FIG. 2, wire 118 passes through wire retainers 115. As shown in FIG. 2, wire retainers 115 are mounted to roof pan 103 between roof pan 103 and photovoltaic panel 106.

The wire retainer may be any currently known or later developed type of wire retainer. Various wire retainer types exist and could be used in place of the wire retainer shown in the figures. In addition to the types of wire retainers existing currently, it is contemplated that the photovoltaic roofing systems described herein could incorporate new types of wire retainers developed in the future.

The number of wire retainers in the photovoltaic roofing system may be selected to meet the needs of a given application. The reader should appreciate that the number of wire retainers may be different in other examples than is shown in the figures. For instance, some photovoltaic roofing system examples include additional or fewer wire retainers than described in the present example.

### Roof Cap

The role of roof cap 117 is to cover roof vent 119 and to overlap integrated covering 107. The reader can see in FIGS. 1-3 that roof cap 117 extends laterally across roof 102 along ridge 111.

Roof cap 117 extends over roof pan 103 and over roof covering members 120 proximate to ridge 111. In particular, as depicted in FIGS. 1-3, roof cap 117 extends from ridge 111 over top edge 116 of roof pan 103. Expressed another way, roof cap 117 overlaps portions of integrated covering 107, namely, roof pan 103 and roof covering members 120, proximate to ridge 111.

In the example depicted in FIGS. 1-3, roof cap 117 is comprised of sheet metal. However, the roof cap may be composed of any currently known or later developed material suitable for roof cap applications. Suitable materials include metals, polymers, ceramics, wood, and composite materials.

The roof cap may be any currently known or later developed type of roof cap. Various roof cap types exist and could be used in place of the roof cap shown in the figures. In addition to the types of roof caps existing currently, it is contemplated that the photovoltaic roofing systems described herein could incorporate new types of roof caps developed in the future.

The size and shape of the roof cap may be varied as needed for a given application. In some examples, the roof cap is larger relative to the other components than depicted in the figures. In other examples, the roof cap is smaller relative to the other components than depicted in the figures. Further, the roof cap and the other components may all be larger or smaller than described herein while maintaining their relative proportions.

### Additional Embodiments

With reference to the figures not yet discussed in detail, the discussion will now focus on additional photovoltaic roofing system embodiments. The additional embodiments include many similar or identical features to photovoltaic roofing system 100. Thus, for the sake of brevity, each feature of the additional embodiments below will not be redundantly explained. Rather, key distinctions between the additional embodiments and photovoltaic roofing system 100 will be described in detail and the reader should reference the discussion above for features substantially similar between the different photovoltaic roofing system examples.

### Photovoltaic Roofing System Embodiment Two

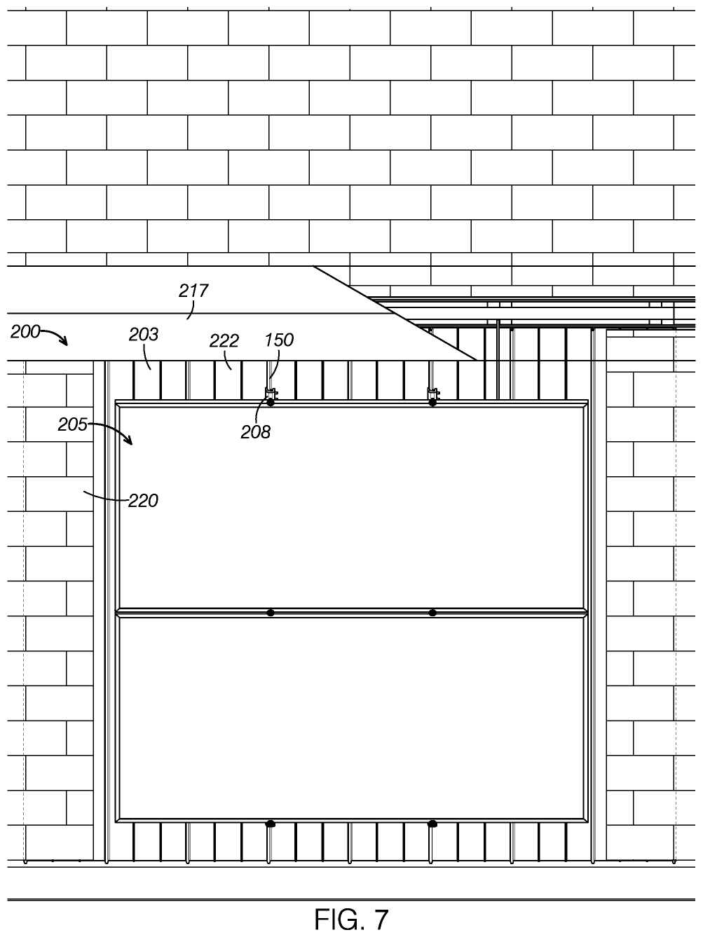

Turning attention to FIG. 7, a photovoltaic roofing system 200 will now be described as a second example of a photovoltaic roofing system. As can be seen in FIG. 7, photovoltaic roofing system 200 includes roof pans 203, photovoltaic devices 205, roof covering members 220, and a roof cap 217. While not visible in FIG. 7, photovoltaic rooting system 200 also includes waterproof fasteners, an inverter, an energy storage device, and a wire retainer.

The primary distinction between photovoltaic roofing system 200 and photovoltaic roofing system 100 relates to the alignment of photovoltaic devices 205 relative to roof pans 203. As shown in FIG. 7, photovoltaic devices 205 are oriented transverse to roof pans 203 in contrast to being aligned like in photovoltaic roofing system 100. More specifically, the longitudinal axes of photovoltaic devices 205 are perpendicular to the longitudinal axes of roof pans 203. With roof pans 203 extending along the pitch of the roof, transversely oriented photovoltaic devices 205 extend across the roof perpendicular to the pitch of the roof.

The reader can see in FIG. 7 that photovoltaic devices 205 couple to roof pans 203 via clamps 208 secured to peripheral ridges 250 of roof pans 203. Roof pans 203 are interconnected standing seam roof pans 222 and peripheral ridges 250 to which the clamp secures are disposed at the seam between two roof pans.

### Photovoltaic Roofing System Embodiment Three

Turning attention to FIG. 8, a photovoltaic roofing system 300 will now be described as a third example of a photovoltaic roofing system. As can be seen in FIG. 8, photovoltaic roofing system 300 includes roof pans 303, rails 340, photovoltaic devices 305, roof covering members 320, and a roof cap 317. While not visible in FIG. 8, photovoltaic roofing system 300 also includes waterproof fasteners, an inverter, an energy storage device, and a wire retainer.

The primary distinction between photovoltaic roofing system 300 and photovoltaic roofing system 100 relates to how photovoltaic devices 305 are secured. As shown in FIG. 8, photovoltaic devices 305 mount to rails 340 rather than by mounting directly to roof pans 303 via a clamp.

In the example shown in FIG. 8, rails 340 secure to peripheral ridges 350 of roof pan 303 via clamps 308. As depicted in FIG. 8, rails 340 extend across roof pans 303 transverse to the longitudinal axis of roof pans 303. By mounting to rails 340 extending across roof pans 303, photovoltaic devices 305 are disposed above roof pans 303.

In the particular example shown in FIG. 8, the longitudinal axes of photovoltaic devices 305 are aligned with the longitudinal axes of roof pans 303. In other examples with rails, the photovoltaic devices may be oriented transverse to the roof pans.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A photovoltaic roofing system, comprising:
a roof pan supported on a deck of a roof;
a photovoltaic device mounted to the roof pan, the photovoltaic device including a photovoltaic panel;
roof covering members mounted to the deck and surrounding and overlapping the roof pan to define an integrated covering;
wherein the roof covering members overlapping the roof pan inhibits water flowing over the integrated covering from flowing between the roof pan and the roof covering members to the deck underneath the integrated covering.

2. The photovoltaic roofing system of claim 1, wherein the roof covering members are one or more of asphalt shingles, concrete tiles, and clay tiles.

3. The photovoltaic roofing system of claim 1, wherein the roof pan is comprised of interconnected standing seam roof pans.

4. The photovoltaic roofing system of claim 3, further comprising waterproof fasteners securing the interconnected standing seam roof pans to the deck.

5. The photovoltaic roofing system of claim 3, wherein:
the interconnected standing seam roof pans are comprised of metal; and
the photovoltaic device includes a clamp coupling the photovoltaic panel to the interconnected standing seam roof pans; and
the clamp is electrically conductive and provides an electrical grounding path between the photovoltaic panel and the interconnected standing seam roof pans.

6. The photovoltaic roofing system of claim 5, wherein:
the number and width of the interconnected standing seam roof pans is selected to cause outermost peripheral ridges of the interconnected standing seam roof pans to align with corresponding outermost edges of the photovoltaic panel; and
the clamp couples one of the outermost edges of the photovoltaic panel to one of the outermost peripheral ridges of the interconnected standing seam roof pans.

7. The photovoltaic roofing system of claim 1, wherein the integrated covering covers the entire deck.

8. The photovoltaic roofing system of claim 7, wherein the deck is covered by the roof covering members where the roof is not covered by the roof pan.

9. The photovoltaic roofing system of claim 8, wherein:
the roof pan terminates below a ridge of the roof; and
the roof covering members extend between the roof pan and the ridge.

10. The photovoltaic roofing system of claim 1, further comprising an inverter electrically coupled to the photovoltaic device and mounted to the roof pan between the roof pan and the photovoltaic panel.

11. The photovoltaic roofing system of claim 1, further comprising an energy storage device electrically coupled to the photovoltaic device and mounted to the roof pan between the roof pan and the photovoltaic panel.

12. The photovoltaic roofing system of claim 11, wherein the roof pan includes a diverter configured to divert water around the energy storage device mounted to the roof pan.

13. The photovoltaic roofing system of claim 1, further comprising a wire retainer mounted to the roof pan between the roof pan and the photovoltaic panel.

14. The photovoltaic roofing system of claim 1, wherein the size and shape of the roof pan and the photovoltaic panel are complementarily configured for the photovoltaic panel to visually hide the roof pan underneath the photovoltaic panel when the photovoltaic roofing system is viewed from the ground.

15. The photovoltaic roofing system of claim 1, wherein:
the roof pan includes a top edge proximate a ridge of the roof; and
the photovoltaic roofing system further comprises a roof cap extending from the ridge over the top edge of the roof pan.

16. The photovoltaic roofing system of claim 15, wherein the roof cap extends laterally across the roof along the ridge and extends over a portion of the roof covering materials proximate the ridge.

17. The photovoltaic roofing system of claim 15, wherein the roof cap is comprised of sheet metal.

18. The photovoltaic roofing system of claim 15, wherein:
the photovoltaic device includes a wire; and
the wire extends under the roof cap into the interior of the roof through a roof vent.

19. The photovoltaic roofing system of claim 1, wherein the photovoltaic panel is spaced less than 2 inches from the roof pan to limit the space between the photovoltaic panel and the roof pan while enabling airflow between the photovoltaic panel and the roof pan.

20. The photovoltaic roofing system of claim 1, wherein the roof pan includes indicia defining mounting regions for the photovoltaic device.
